(19) United States
(12) Patent Application Publication
(10) Pub. No.: US 2011/0130977 A1
(43) Pub. Date: Jun. 2, 2011

(54) SYSTEM FOR MEASURING MILK FLOW AT A MILKING INSTALLATION

(75) Inventor: Nicholas Phillpot, D.N. Yizrael (IL)

(73) Assignee: E.N.G.S. SYSTEMS LTD., Rosh Pinna (IL)

(21) Appl. No.: 12/936,623

(22) PCT Filed: Apr. 16, 2009
(86) PCT No.: PCT/IL2009/000415

§ 371 Date: Jan. 25, 2011

Related U.S. Application Data
(62) Division of application No. 61/064,994, filed on Apr. 8, 2008.

(51) Int. Cl. G01F 1/56; G06F 19/00

(52) U.S. Cl. 702/45

(57) ABSTRACT

Provided is a system for measuring milk flow at a milking installation. A first electrode and a second electrode are positioned inside a milk conduit across which a fixed voltage is applied. Milk flowing in the conduit forms a resistive element between the electrodes. Electric current in the milk between the two electrodes is detected by an ammeter, amplified by an amplifier, and then stored in a memory. A processor is configured to determine the current flow rate of milk in the conduit between the electrodes. The processor is further configured to determine the time averaged value of the amplified current over a recent time window. If the determined average is not within a predetermined range, the processor determines a gain of the amplifier that would have brought this time average into the predetermined range. The processor then resets the gain of the amplifier to the determined gain in order to bring the time average of the amplified current over subsequent time windows into the predetermined range.

### FIELD OF THE INVENTION

This invention relates to

### BACKGROUND OF THE INVENTION

Automation of the milking of dairy cattle requires automatic determination of the volume of milk produced by each animal milked at a milking installation. However, automatic volume determination is made difficult due to the fact that milk flow from an animal being milked is pulsatile in nature and is not uniform. The problem is compounded by the fact that the milk is not homogenous, but it has many phases consisting of a liquid phase and a foam phase.

One method for measuring milk flow uses a measuring chamber in which either the weight of the contents is determined with a tipping cart or the volume is determined with a floater or sensor electrodes. Milk enters the chamber in small portions and the volume or weight of each portion is measured. The chamber is then emptied before the next portion enters the chamber. Devices which measure milk flow in a conduit using ultrasound or infrared sensors are also known.

Devices for the measurement of flow meters are disclosed, for example, in U.S. Pat. Nos. 5,083,459 and 7,155,971, and in EP 0 315 201 A2.

### SUMMARY OF THE INVENTION

The present invention provides a system for measuring milk flow at a milking installation. The system includes a conduit in which milk received from an animal being milked at the installation flows. A first electrode and a second electrode are positioned inside the milk conduit across which a fixed voltage is applied. Milk flowing in the conduit forms a resistive element between the electrodes. Electric current in the milk between the two electrodes is detected by an ammeter, amplified by an amplifier, and then stored in a memory. A processor is configured to determine the current flow rate of milk in the conduit between the electrodes. Typically, the flow rate is determined from a look up table that provides the milk flow rate from the stored amplified current and the current value of the gain of the amplifier. The current flow rate is stored in the memory, together with the time at which the flow rate was measured. The processor is further configured to determine the time averaged value of the amplified current over a recent time window. If the determined average is not within a predetermined range, the processor determines a gain of the amplifier that would have brought this time average into the predetermined range. The processor then resets the gain of the amplifier to the determined gain in order to bring the time average of the amplified current over subsequent time windows into the predetermined range.

Thus, in its first aspect, the invention provides a system for determining a flow rate of milk collected at a milking installation, comprising:
(a) a conduit;
(b) a first electrode and a second electrode, the first and second electrodes being disposed in an interior lumen of the conduit, and spaced apart in the lumen;
(c) a power supply providing a voltage across the first and second electrodes;
(d) an electric current meter determining an electrical current between the first and second electrodes, the electric current being indicative of a volume of milk in the conduit between the first and second electrodes;
(e) an amplifier having a selectable gain amplifying an output of the amp meter;
(f) an analogue to digital converter sampling an output of the amplifier and generating a digital signal;
(g) a memory storing an output of the analog to digital converter; and
(h) a processor configured to :
   calculate a flow of milk in the conduit using one or more output samples of the analogue to digital converter;
   calculate an average of the n most recent output values from the analog to digital converter, where n is an integer;
   calculate the amplifier gain that would bring the average of the last n output values into a predetermined range when the calculated time average not in the predetermined range; and
   adjust the amplifier gain to the calculated gain.

The processor may further be configured to calculate a cumulative volume flow in the conduit using one or more of the calculated flows.

In another of its aspects, the invention provides a processor for use in a system for determining a flow rate of milk collected at a milking installation, the milking installation comprising:
(a) a conduit;
(b) a first electrode and a second electrode, the first and second electrodes being disposed in an interior lumen of the conduit, and spaced apart in the lumen;
(c) a power supply providing a voltage across the first and second electrodes;
(d) an electric current meter determining an electrical current between the first and second electrodes, the electric current being indicative of a volume of milk in the conduit between the first and second electrodes;
(e) an amplifier having a selectable gain amplifying an output of the amp meter;
(f) an analogue to digital converter sampling an output of the amplifier and generating a digital signal;
(g) a memory storing an output of the analog to digital converter;
   wherein the processor is configured to :
   calculate a flow of milk in the conduit using one or more output samples of the analogue to digital converter;
   calculate an average of the n most recent output values from the analog to digital converter, where n is an integer;
   calculate the amplifier gain that would bring the average of the last n output values into a predetermined range when the calculated time average not in the predetermined range; and
   adjust the amplifier gain to the calculated gain.

The invention further provides a method for determining a flow rate of milk collected at a milking installation, the milking installation comprising:
(a) a conduit;
(b) a first electrode and a second electrode, the first and second electrodes being disposed in an interior lumen of the conduit, and spaced apart in the lumen;
(c) a power supply providing a voltage across the first and second electrodes;
(d) an electric current meter determining an electrical current between the first and second electrodes, the electric current being indicative of a volume of milk in the conduit between the first and second electrodes;
(e) an amplifier having a selectable gain amplifying an output of the amp meter;
(f) an analogue to digital converter sampling an output of the amplifier and generating a digital signal;
(g) a memory storing an output of the analog to digital converter; and
   wherein the method comprises :
   calculating a flow of milk in the conduit using one or more output samples of the analogue to digital converter;
   calculating an average of the n most recent output values from the analog to digital converter, where n is an integer;
   calculating the amplifier gain that would bring the average of the last n output values into a predetermined range when the calculated time average not in the predetermined range; and
   adjusting the amplifier gain to the calculated gain.

The system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 shows a system for measuring milk flow at a milking installation in accordance with one embodiment of the invention;

FIG. 2 shows the milk flow measuring system of FIG. 1 in greater detail; and FIG. 3 shows a flow chart for adjusting the gain of the amplifier carried out by the processor of the system of FIGS. 1 and 2.

### DETAILED DESCRIPTION OF EMBODIMENTS

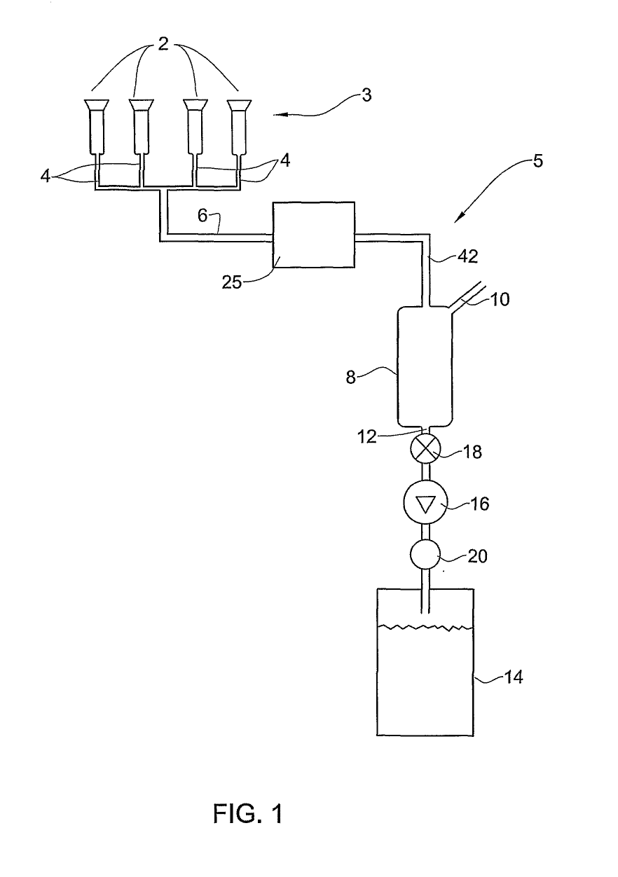

FIG. 1 shows a system, generally indicated by 25 for measuring milk flow at a milking installation 5 in accordance with one embodiment of the invention. The milking installation 5 includes one or more milking apparatuses for milking an animal. Each milking apparatus includes a cluster 3 of four teat cups 2 configured to be connected to the teats of an animal to be milked. Milk received in the teat cups 2 is conducted via milk discharge tubes 4 and a conduit 6 to a milk glass 8. As milk flows in the conduit 6, the flow of milk is monitored by the flow measuring system 25, as explained below. The milk glass 8 is also connected to a vacuum line 10 for generating a vacuum in the milk conduction system consisting of the teat cups 2, the milk discharge tubes 4, the milk conduit 6 and milk glass 8, in order to maintain the teat cups 2 on the teats of the animal being milked, and for conducting milk from the teat cups 2 to the milk glass 8 where air present in the milk is separated from the milk. The milk received in the milk glass 8 is subsequently conducted through an exit conduit 12 to a bulk milk tank 14 under the influence of a pump 16. The exit conduit 12 is provided with a valve 18, and a non-return valve 20.

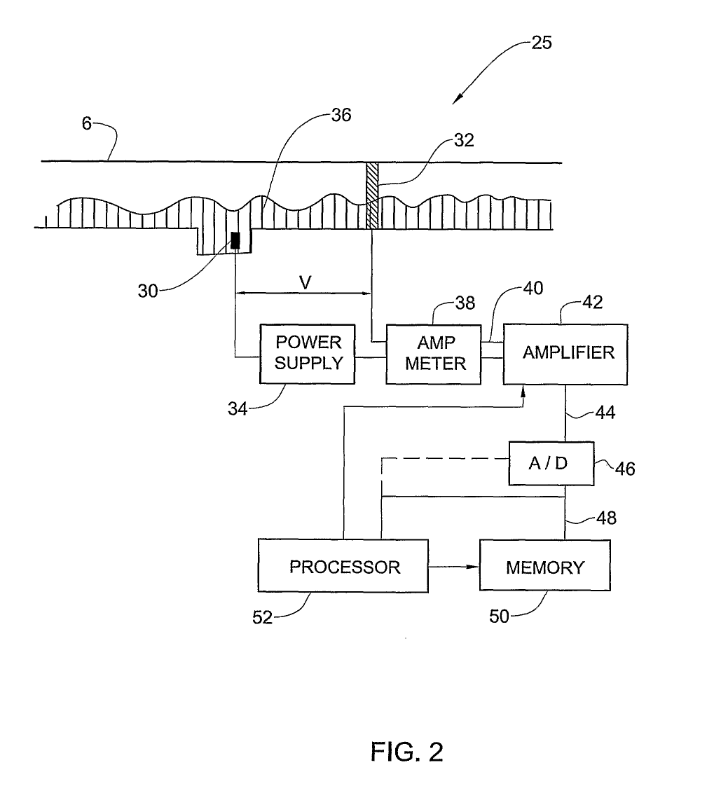

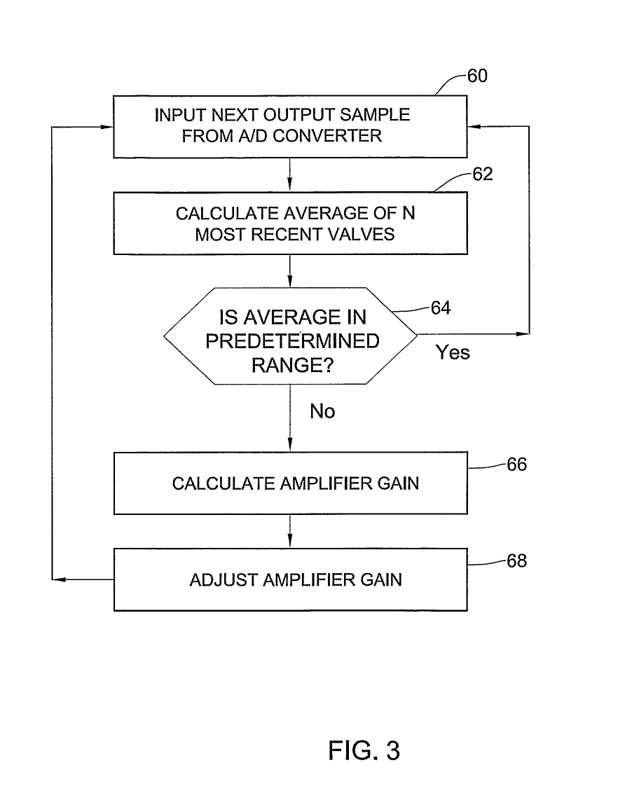

FIG. 2 shows the milk flow measuring system 25, in accordance with one embodiment of the invention. The system 25 includes a first electrode 30 and a second electrode 32. The electrodes 30 and 32 are positioned inside the milk conduit 6. A fixed voltage V is applied across the electrodes 30 and 32 by a power supply 34. Milk 36 flowing in the conduit 6 forms a resistive element between the electrodes 30 and 32. Electric current in the milk between the two electrodes 30 and 32 is detected by an analogue amp meter 38. The output signal 40 of the amp meter 38 is amplified by an analogue amplifier 42 having a selectable gain. The amplified signal 44 is digitized by an analogue to digital converter 46. The output 48 of the A/D converter 46 is stored in a memory 50 and is simultaneously input to a processor 52.

The processor 52 is configured to determine the current flow rate of milk in the conduit 6 between the electrodes 30 and 32 from the current value of the output 48 from the A/D converter 46. Typically, the flow rate is determined from a look up table that provides the milk flow rate from the output 48 and the current value of the gain of the amplifier 42. The current flow rate is stored in the memory 50, together with the time at which the flow rate was measured. The processor 52 is also configured to access the memory 50 over a recent time period and determined the cumulative volume of milk that flowed in the conduit 6 during the time period from the flow rates measured during the time period.

In accordance with the invention, the processor 52 is further configured to access the memory 50 and to determine the time averaged value of the output 48 over a recent time window consisting of the n most recent values of the signal 48. If the determined average is not within a predetermined range, the processor determines a gain of the amplifier 42 that would have brought this time average into the predetermined range. The processor 52 is further configured to reset the gain of the amplifier 42 to the determined gain in order to bring the time average of the output 48 over subsequent time windows into the predetermined range.

FIG. 3 shows a flow chart for adjusting the gain of the amplifier 42 carried out by the processor 52. In step 60, the next output sample from the A/D converter 46 is input to the processor 52 and to the memory 50. In step 62, the average of the n most recent output values from the A/D converter is calculated, where n is an integer. Then, in step 64 it is determined whether the calculated time average is in the predetermined range. If yes, then the process returns to step 60 with the next output value from the A/D converter being input to the processor 52 and the memory 50. If no, then in step 66 the processor calculates the amplifier gain that would have brought the average of the last n output values into the predetermined range, and in step 68 the processor adjusts the amplifier gain to the calculated gain. The process then returns to step 60 with the next output value from the A/D converter being input to the processor 52 and the memory 50.

1. A system for determining a flow rate of milk collected at a milking installation, comprising:
(a) a conduit;
(b) a first electrode and a second electrode, the first and second electrodes being disposed in an interior lumen of the conduit, and spaced apart in the lumen;
(c) a power supply providing a voltage across the first and second electrodes;
(d) an electric current meter determining an electrical current between the first and second electrodes, the electric current being indicative of a volume of milk in the conduit between the first and second electrodes;
(e) an amplifier having a selectable gain amplifying an output of the amp meter;
(f) an analogue to digital converter sampling an output of the amplifier and generating a digital signal;
(g) a memory storing an output of the analog to digital converter; and
(h) a processor configured to:
calculate a flow of milk in the conduit using one or more output samples of the analogue to digital converter;
calculate an average of the n most recent output values from the analog to digital converter, where n is an integer;
calculate the amplifier gain that would bring the average of the last n output values into a predetermined range when the calculated time average not in the predetermined range; and
adjust the amplifier gain to the calculated gain.

2. The system according to claim 1, wherein the processor is further configured to calculate a cumulative volume flow in the conduit using one or more of the calculated flows.

3. A processor for use in a system for determining a flow rate of milk collected at a milking installation, the milking installation comprising:
(a) a conduit;
(b) a first electrode and a second electrode, the first and second electrodes being disposed in an interior lumen of the conduit, and spaced apart in the lumen;
(c) a power supply providing a voltage across the first and second electrodes;
(d) an electric current meter determining an electrical current between the first and second electrodes, the electric current being indicative of a volume of milk in the conduit between the first and second electrodes;
(e) an amplifier having a selectable gain amplifying an output of the amp meter;
(f) an analogue to digital converter sampling an output of the amplifier and generating a digital signal;
(g) a memory storing an output of the analog to digital converter;
wherein the processor is configured to:
calculate a flow of milk in the conduit using one or more output samples of the analogue to digital converter;
calculate an average of the n most recent output values from the analog to digital converter, where n is an integer;
calculate the amplifier gain that would bring the average of the last n output values into a predetermined range when the calculated time average not in the predetermined range; and
adjust the amplifier gain to the calculated gain.

4. A method for determining a flow rate of milk collected at a milking installation, the milking installation comprising:
(a) a conduit;
(b) a first electrode and a second electrode, the first and second electrodes being disposed in an interior lumen of the conduit, and spaced apart in the lumen;
(c) a power supply providing a voltage across the first and second electrodes;
(d) an electric current meter determining an electrical current between the first and second electrodes, the electric current being indicative of a volume of milk in the conduit between the first and second electrodes;
(e) an amplifier having a selectable gain amplifying an output of the amp meter;
(f) an analogue to digital converter sampling an output of the amplifier and generating a digital signal;
(g) a memory storing an output of the analog to digital converter; and
wherein the method comprises:
calculating a flow of milk in the conduit using one or more output samples of the analogue to digital converter;
calculating an average of the n most recent output values from the analog to digital converter, where n is an integer;
calculating the amplifier gain that would bring the average of the last n output values into a predetermined range when the calculated time average not in the predetermined range; and
adjusting the amplifier gain to the calculated gain.

5. A computer program comprising computer program code means for performing all the steps of claim 4, when the program is run on a computer.

6. A computer program as claimed in claim 5, embodied on a computer readable medium.
